(19) United States
(12) Patent Application Publication
(10) Pub. No.: US 2001/0043882 A1
(43) Pub. Date: Nov. 22, 2001

(54) Analyzing system for analyzing medical samples

(76) Inventors: Hans Berger, Graz (AT); Ulrich Kanter, Unterpremstatten (AT); Hellfried Karpf, Graz (AT); Werner Ziegler, Graz (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 09/854,523

(22) Filed: May 15, 2001

(30) Foreign Application Priority Data
May 16, 2000 (EP) 00890155.5

(51) Int. Cl. G01N 35/00

(52) U.S. Cl. 422/67

(57) ABSTRACT

A flexible, extendable analyzing system for analyzing medical samples, and preferably for analysis of body fluids, is provided with one or several independent single analyzers for measuring a single parameter or parameter group each, and a computer-supported central unit with an input/output unit. The single analyzers are coupled to the central unit in a first position, i.e., the charging position, from which they can be removed and inserted in a second position, i.e., the measuring position, preferably a bedside measuring position. The single analyzers coupled to the central unit in the charging position form a multi-component analyzer.

### BACKGROUND OF THE INVENTION

The invention relates to an analyzing system for analyzing medical samples, and preferably for analysis of body fluids. A considerable number of electrochemical and electro-optical analyzers are in use today for applications in the laboratory or clinic, which must meet diverse demands. They include simple, essentially manually operated devices as well as complex, highly automated analyzers and analyzing systems. In general, laboratories use a variety of analyzers side by side, which are supplied by different manufacturers and require different operating steps for sample preparation, measuring, maintenance and documentation of the measured results. For large volumes of samples laboratories frequently require highly automated analyzers with fast sample throughput, which will usually permit only a restricted menu of choices. Other sample parameters, which are determined less frequently, often necessitate the purchase of additional analyzers, requiring additional operating staff, additional space in the laboratory, separate sample preparation and additional effort for administration and documentation of measurement data, on top of the investment necessary in the first place.

### DESCRIPTION OF PRIOR ART

For these reasons analyzing systems have been developed, in which two analyzers with different sample throughput and different analyzing choices are combined into a modular analyzing system combining the advantages of the individual analyzers. Such a system is described in U.S. Pat. No. 4,965,049 for instance. The two individual analyzers of the analyzing system each have a revolving sample holder, corresponding facilities for sample analysis, and tiltable elements for sample withdrawal, which deliver the sample from the holder to the analyzers. After removal of the side elements of adjacent housing parts of both single analyzers, the latter can be combined into an analyzing system following accurate adjustment by means of distance elements, such that the tiltable sampling element of the first analyzer has access to the samples in the holder of the second modular analyzer. As all samples of the analyzing system are entered via the sample holder of the second analyzer, the revolving sample holder of the first analyzer can be removed once the two analyzers have been combined.

In order to synchronize the tiltable sampling element of the first analyzer with the revolving sample holder of the second analyzer, and to exchange readings between the two analyzers, the two analyzers are linked by a data bus. Moreover, both analyzers are provided with a common system for a washing solution, the required tubes going through adjacent sidewalls of the analyzer housings.

The drawback of this system is that it will hardly permit further addition of individual analyzers, and that once the two individual analyzers have been combined to form an analyzing system, they cannot be employed independently as separate analyzers in different locations without necessitating time-consuming disassembly work.

In the critical care field user-friendly, automated analyzers are used routinely, which are capable of determining a large number of different parameters or groups of parameters of a medical sample. One example would be the modular analyzer AVL-OMNI (AVL Medical Instruments AG, Schaffhausen, CH), which has a sample input and several measuring modules which can be individually selected for a particular analyzing task. Among others, modules for blood gas analysis (pH, PCO₂, P0₂), electrolyte measurement (Na⁺, K⁺, CL⁻, Ca⁺⁺), determination of hemoglobin and CO oximetry, may be inserted into the analyzer. The complex device, which is furnished with a user-friendly touch-screen, a thermo-printer, and high-quality evaluation electronics plus memory for patient data, is perfectly suited for laboratory use, but it will not permit individual bedside-testing without blocking the entire analyzer regarding other measuring tasks.

### SUMMARY OF THE INVENTION

It is an object of the present invention to propose a flexible analyzing system for analyzing medical samples based on the analyzers and analyzing systems described above, which offers add-on possibilities and combines the advantages of compact, easily operable, individual instruments and those of a multi-component analyzer.

According to the invention this object is achieved by providing one or several independent single analyzers for determining one sample parameter or parameter group each, and a computer-supported central unit with an input/output unit, and by coupling the single analyzers in a first position, i.e., the charging position, to the central unit, and by designing the single analyzers so as to be removable from the charging position and insertable in a second position, preferably a measuring position next to the patient a so called bedside measuring position. The analyzing system thus combines easily operable, user-friendly single analyzers and a computer-supported central unit serving as a charging station for the single analyzers. The single analyzers in the charging position will permit the analyzing system to be used as an automatic multi-component analyzer with flexible extension capacity, whose components can easily be exchanged for different ones. It will be possible to remove the single analyzers from the charging position with very little effort, and to insert them in a measuring position preferably next to the patient, thus employing them for sample analysis in a decentralized manner. The analyzing system will allow the use of diverse single analyzers for measuring different parameters or parameter groups and of a plurality of identical single analyzers for measuring one and the same parameter group, if an increase in sample throughput is desired. It would be possible to use several single analyzers for blood gas analysis, some of which are inserted in measuring positions next to the patient, while others are placed in the charging position and coupled to the central unit where they are prepared for the measuring task of the latter.

In the analyzing system proposed by the invention a bus system is of particular advantage, which will establish releasable contact between single analyzers and central unit in the charging position, and contact between the single analyzers.

In a simple configuration of the invention the bus system is provided with a data bus to establish a data link between the individual components of the analyzing system. Furthermore, an energy supply bus may be integrated into the bus system, in order to permit rechargeable energy storage cells such as accumulators, to be recharged in the single analyzers in charging position.

In further development of the invention the bus system may be provided with a fluid bus for an exchange of washing, calibrating, and quality control solutions between the individual components, such that the individual media may be delivered from supply tanks in the central unit via the bus system to the single analyzers as desired.

The bus system could also be furnished with a sample bus for exchanging the sample fluid between the individual components, such that a sample fed into the central unit or one of the single analyzers can be transferred to other single analyzers for further analysis.

It is provided in a particularly advantageous variant that the bus system comprise docking stations for the single analyzers, which include releasable plug-in and docking connections for the transport of data, energy, fluids and/or samples. The docking stations may be coupled to each other (e.g., via lateral connecting surfaces) and to the central unit, establishing releasable plug-in and docking connections for delivery of data, energy, fluids and/or samples. In this way the analyzing system can be extended in a simple manner by adding on further docking stations. It will not be necessary to provide an individual docking station for each single analyzer, as docking stations and docking sites of the single analyzers preferably are all of the same design, so that only one type of docking station may be used for different types of single analyzers. Of a plurality of single analyzers some may be coupled to the central unit in charging position, while others will be used for independent measuring tasks, remote from the central unit. When a single analyzer is removed from the docking station of the bus system all electric connections and fluid connections are disconnected simultaneously and the fluid connections in the bus system and in the single analyzer are closed automatically by magnetic valves, sealing lips, or elastic seal elements. All connections are reestablished by simply inserting the single analyzer into a docking station. In a further variant of the invention the bus system is provided with a cable or tube connection for each single analyzer, leading from a socket at the central unit to a socket at the analyzer used at the time, for the delivery of data, energy, fluids and/or samples. Each single analyzer need only be connected in charging position to the central unit by a plug-in connection, which will automatically connect all lines integrated in the particular bus system. Via the data bus of the bus system the single analyzers are identified by means of suitable software routines stored in the central unit.

The invention provides that single analyzers be used for measuring the parameter groups of blood gases with pH, electrolytes, metabolites, CO-oximetry, hematology, coagulation, and immunology.

In a further variant of the invention the central unit can also be provided with an analyzer for measuring at least one parameter or parameter group of the medical sample to be analyzed.

In order to obtain single analyzers of low weight and compact size the central unit may be provided with supply tanks connected to the bus system for washing, calibrating, and quality control media, and a waste container for exhausted samples as well as washing, calibrating and quality control media.

The independent single analyzers feature an input element (foil-covered keyboard, or bar code reader, etc.) for entering patient data during measuring remote from the central unit. In addition, a display element is provided for optical display of the readings. The measured results can be further processed or printed upon insertion into the central unit by the evaluation facilities and printers provided in this unit. The measurement data can be automatically transferred to the patient file in the central unit.

The central unit is further provided with control and maintenance facilities for the single analyzers, which are initiated by software routines in the central unit.

In an especially advantageous variant the central unit includes a connection for remote data transmission, and preferably an intranet and/or internet connection. In this context the central unit may feature a device for automatic recording of information on operating materials and supplies, in particular for recording the type and maximum useful life of the operating materials used, as well as types, expiry dates, and quantities of supplies used in an analyzer, and further a device for automatically calculating the estimated frequency of analysis from past frequencies of use of the analyzer, or an input unit for entering the desired frequency of analysis, and further a device for calculating the operating materials and/or supplies required per unit of time in depedence of data on operating materials and supplies as well as frequency of analysis, the said device being connected to the connection for remote data transmission for automated transmission of data concerning product ordering, service, and maintenance.

The special advantage of this variant is that essential parts of the operating materials and supplies management of an analyzing system are automated. Recording of data after insertion of new sensor cartridges (units or modules which may be exchanged by the user, usually comprising several single sensors for different parameters in a measuring chamber) or other supplies may be effected by means of a bar code reader or a transponder system, where a memory chip is provided on or in each sensor cartridge and each supply tank. The memory chip, for instance at the container for the calibrating medium, may also be used for storing the current filling level of the calibrating medium. Besides, it will suffice to enter the desired frequency of analysis once, i.e., analyses planned per unit of time, or the frequency of analysis is suggested by the analyzer itself on the basis of data collected in previous periods of use, and confirmed by the user. This is followed by an automatic calculation of the operating materials and supplies required per unit of time, and the determination of an optimum reordering point, the location of the analyzer and, as a consequence, the time required for the entire transaction of ordering and delivery being taken into account.

Automatic reordering can be effected via internet, for example, where a direct contact is established with manufacturer, supplier, and service department or user center. The process is extremely time-saving and safe for the user, as it will not be necessary to fill out order forms or maintain an address file, and faulty information and orders will be avoided.

Advantageously, the internet access of the analyzing system concerning the input and output elements (keyboard, monitor, printer) of the central unit can also be used for ordering other products in the medical or clinical context. The analyzing system thus will assume a portal function, in addition to facilitating the management of supplies for other equipment or offering user access to electronic information media (newsletters, magazines, etc.).

By means of a single activation in the set-up program of the analyzing system or upon concluding a pertinent maintenance contract, the user will receive via internet (push technology) the information and updates precisely corresponding to his needs and system configuration, respectively, thus optimizing his working conditions.

It will be of further advantage if the user is offered a help function via automatic remote data transmission. In this way the user can communicate with the manufacturer, a user center, user groups, the supplier of operating materials, or the service department (chat room).

The internet connection can further be used for remote repair of hardware or software components of the analyzing system or the central unit and single analyzers linked therewith. Remote repair is preceded by analysis of potential error messages and analysis of the latest calibration and quality control cycles. Via the service department communicating via internet, service routines that are preconfigured in the analyzer may then be initiated to repair the fault. Moreover, programs may be downloaded which will permit fault repair by routinely utilizing analyzer components or making a special use of these components in the analyzer. By repeated washing of the sample passages, by reversing the direction of flow, or by changing the sequence of certain operational steps, it will be possible to remove deposits or contaminations in the sample passage which are not eliminated by routine washing or scrubbing.

Automatic reordering of operating materials and supplies either is effected fully automatically by the central unit after a pertinent function has been activated once, or it is proposed by the analyzing system and confirmed by the user. For calculation of the operating materials and supplies required per unit of time it will be possible to enter the desired range (stock of supplies needed for a desired period of time) and/or desired availability (planned workload) of the analyzer.

The data collected and computed by the analyzing system are used to calculate service and maintenance intervals, and the respective service and maintenance can be requested or ordered via the internet connection using a remote maintenance service. For the computer software concerned in this service and maintenance context, it will be possible to automatically request new versions of evaluation programs or update versions of the operating system.

Use of the internet connection of the central unit will also permit the recording of error messages arriving from hardware or software components of the analyzer, automatic error diagnosis and the requesting or ordering of respective service and maintenance jobs via the automatic remote data transmission.

It is further provided that the central unit should be furnished with a data link to a laboratory information system (LIS), and a hospital information system (HIS), and/or further laboratory systems (LS) without an internet connection of their own.

It is provided in yet another variant of the invention that the central unit and the single analyzers have transmitter/receiver systems for wireless data transfer, such that a data link will be upheld if the single analyzer is at a measuring position remote from the central unit. The transfer of data between the central unit and the single analyzers, and the data link to the information systems LIS and HIS may be effected by means of wireless technology in the 2.4 GHz range, utilizing the license-free ISM band (industrial, scientific, medical band).

### BRIEF DESCRIPTION OF THE DRAWINGS

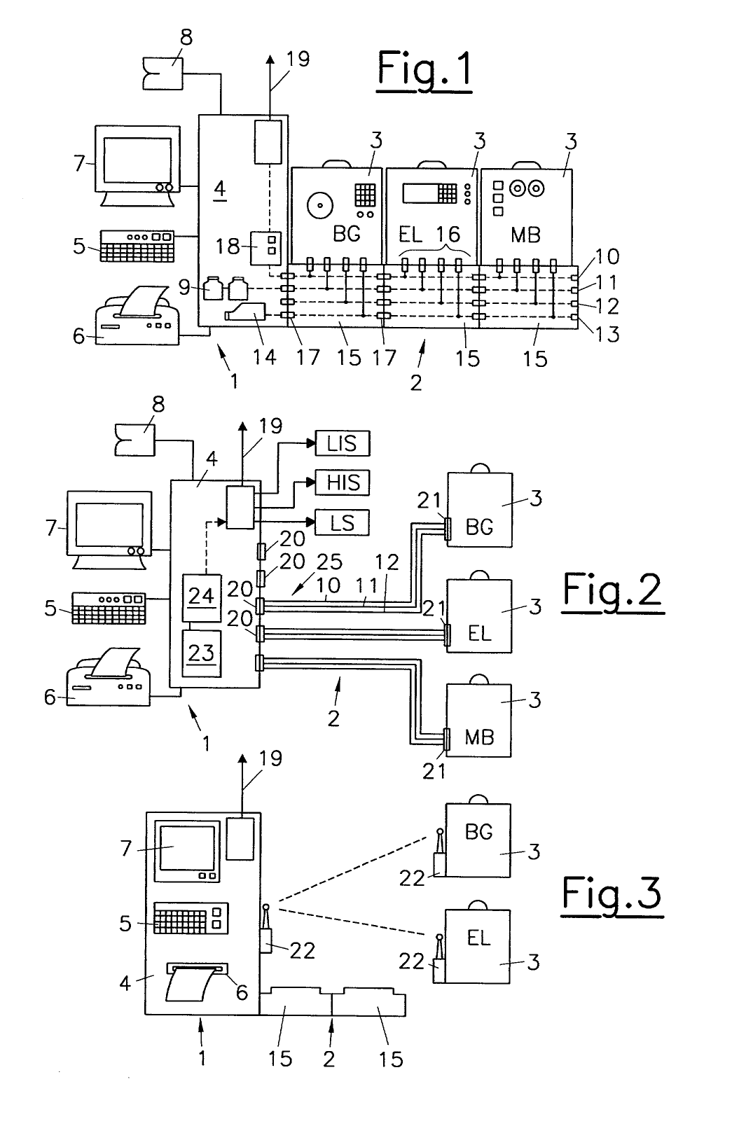

The invention will now be explained in more detail with reference to the accompanying drawings, wherein FIG. 1 is a schematical representation of an analyzing system for analysis of medical samples, and FIGS. 2 and 3 show variants of the analyzing system presented in FIG. 1.

### DETAILED DESCRIPTION OF THE PREFERRED EMBODIMENTS

The analyzing system for analysis of body fluids according to FIG. 1 is configured as a central unit 1 and independent single analyzers 3 linked thereto via a bus system 2. The single analyzers 3, for example, a blood gas analyzer BG, an electrolyte analyzer EL, and an analyzer for different metabolites MB, are coupled to the central unit 1 in a first position, i.e., the charging position shown in FIG. 1, thus forming a multi-component analyzer. The single analyzers 3 may be removed from this charging position by means of a gripping element and transferred to a measuring position remote from the central unit 1.

The central unit 1 is provided with a computer 4 with corresponding evaluation and control software, data bases, etc., as well as integrated or computer-connected input and output elements, such as keyboard 5, printer 6, and monitor 7. The central unit 1 may further include a bar code reader 8 and an electronic connection 19 for remote data transmission (connection to the central computer of the laboratory or clinic, intranet, internet, etc.). The single analyzers 3 have sample input devices and simple data input and display elements, enabling the analyzers to operate as autonomic units, independently of the central unit 1. If necessary, temporary reservoirs for the washing and calibrating media (not shown here) may be provided in the single analyzers 3.

The bus system 2 includes at least one data bus 10 for connection of the central unit 1 to the independent single analyzers 3. The system under discussion also features a fluid bus 11 for exchanging washing, calibrating, and quality control media between the single analyzers 3, a connection to the central unit 1 being provided, if required.

If the single analyzers 3 are not furnished with a separate energy supply, an energy supply bus 12 departing from the central unit 1 may be integrated in the bus system 2. Finally, a sample bus 13 is provided, which is used to exchange the sample between the single analyzers, and is connected to a waste container 14 in the central unit 1.

In the variant of FIG. 1 the bus system 2 essentially comprises identical types of docking stations 15 for each single analyzer 3, which have releasable plug-in and docking connections 16 for the individual bus components. Some or all of the docking stations 15 may contain tanks for a washing, calibrating, or quality control medium, which are connected to the fluid bus 11. Such tanks 9 also may be provided in the central unit 1 for supplying all single analyzers. It will thus be possible quite simply to remove each single analyzer 3 from its docking station 15 and use it in some other location as independent analyzer for certain parameters or parameter groups. In order to increase sample throughput several identical single analyzers 3 could be used in an analyzing system.

Via the control and maintenance unit 18 located in the central unit 1 certain maintenance and service jobs may be executed for the single analyzers 3, and an automatic configuration of the overall system may be executed via the data bus. The control and maintenance unit 18 is furnished with a connection 19 for remote data transmission, so that a remote access may be established via an internet connection for the purpose of remote diagnosis and remote maintenance.

Since the docking stations 15 can be coupled with each other and with the central unit 1 via lateral connecting faces in the way of a modular system, releasable plug-in and docking connections 17 being established for the individual bus components, the analyzing system can be extended whenever necessary by additional docking stations 15 and corresponding single analyzers 3.

The variant shown in FIG. 2 differs from that in FIG. 1 in that the bus system 2 connects the single analyzers 3 to the central unit 1 in a star configuration. Data bus 10, fluid bus 11 and energy supply bus 12 are combined in cable and tube connections leading from sockets 20 at the central unit 1 to sockets 21 at the single analyzers 3. After the single analyzer 3 has been unplugged it may be used as an independent unit. The entire system may be extended by plugging additional single analyzers into the sockets 20 of the central unit 1.

As is shown in the variant of FIG. 2 the central unit 1 may be provided with a unit 23 for computation of the frequency of analysis to be expected on the basis of information on past frequencies of use, and a unit 24 for calculation of the operating materials and supplies required per unit of time. The analyzing system makes use of connection 19 for remote data transmission to automatically transmit the product ordering, service and maintenance data obtained by unit 24. It will also be possible to use the input unit and keyboard 5 for entering the desired or expected frequency of analysis. The analyzer may further include a data link to a laboratory information system LIS, and to a hospital information system HIS, and to other laboratory systems LS. Above all, connection of systems will be possible that do not have an internet connection of their own.

The transfer of data between the central unit 1 and the single analyzers 3, and the data link to a laboratory information system LIS and hospital information system HIS may be effected by means of wireless technology in the 2.4 GHz range, utilizing the ISM band.

Another, compact variant of the invention is shown in FIG. 3, in which the single analyzers 3 are presented in a measuring position remote from the central unit 1. Transmitter/receiver units 22 at the central unit 1 and the single analyzers 3 will permit wireless data transfer between the individual components in the measuring position.

What is claimed is:

1. An analyzing system for analyzing medical samples comprising:
at least one independent single analyzer each of said single analyzers are provided for determining one sample parameter or one sample parameter group,
a computer-supported central unit having an input/output unit,
wherein said single analyzers are coupled in a first position, i.e., a charging position, to said central unit, and
wherein said single analyzers are designed so as to be removable from said charging position for use in a second position, i.e., a measuring position.

2. An analyzing system according to claim 1, wherein said measuring position is a bedside measuring position.

3. An analyzing system according to claim 1, wherein a bus system is provided for establishing releasable contact between each of said single analyzers as well as for establishing releasable contact between said single analyzers and said central unit in said charging position.

4. An analyzing system according to claim 3, wherein said bus system is provided with a data bus to establish a data link between said single analyzers and said central unit.

5. An analyzing system according to claim 3, wherein said bus system is provided with a fluid bus for exchange of washing, calibrating, and quality control solutions between said single analyzers and said central unit.

6. An analyzing system according to claim 3, wherein said bus system is provided with an energy supply bus.

7. An analyzing system according to any claim 3, wherein said bus system is provided with a sample bus for exchange of sample fluids between said single analyzers and said central unit.

8. An analyzing system according to claim 3, wherein said bus system is provided with docking stations for docking said single analyzers, each of said docking stations includes releasable plug-in and docking connections for at least one of data, energy, fluid and sample transport.

9. An analyzing system according to claim 8, wherein said docking stations are coupled to each other and to said central unit, establishing releasable plug-in and docking connections for at least one of data, energy, fluid and sample transport.

10. An analyzing system according to claim 8, wherein all of said docking stations and docking sites of said single analyzers are of uniform type.

11. An analyzing system according to claim 3, wherein said bus system is provided with a cable or tube connection for each of said single analyzers, leading from a socket at said central unit to a socket at each of said single analyzers, for at least one of data, energy, fluid and sample transport.

12. An analyzing system according to claim 1, wherein said single analyzers are provided for measuring at least one parameter of a group consisting of blood gases with pH, electrolytes, metabolites, CO-oximetry, hematology, coagulation, and immunology.

13. An analyzing system according to claim 1, wherein said central unit is provided with an analyzer for measuring at least one parameter or parameter group of said medical sample to be analyzed.

14. An analyzing system according to claim 1, wherein said central unit is provided with control and maintenance facilities for each of said single analyzers.

15. An analyzing system according to claim 1, wherein said central unit is provided with supply tanks for at least one fluid of a group consisting of washing, calibrating, and quality control media, and a waste container for exhausted samples and washing, calibrating and quality control media.

16. An analyzing system according to claim 1, wherein said central unit is provided with a connection for remote data transmission.

17. An analyzing system according to claim 16, wherein said remote data transmission is an intranet connection.

18. An analyzing system according to claim 16, wherein said remote data transmission is an internet connection.

19. An analyzing system according to claim 1, used for analysis of body fluids.

20. An analyzing system according to claim 16, wherein said central unit comprises:
a device for automatic recording of information on operating materials and supplies,
a device for automatically calculating an estimated frequency of analysis from past frequencies of use of said analyzing system, or an input unit for entering a desired frequency of analysis, and
a device for calculating said operating materials and supplies required per unit of time in dependence of data on said operating materials and supplies as well as said frequency of analysis,
wherein said device for calculating is connected to said connection for remote data transmission for automated transmission of data concerning product ordering, service, and maintenance.

21. An analyzing system according to claim 20, wherein said device for automatic recording of information is used for recording type and maximum useful life of said operating materials used, as well as types, expiry dates, and quantities of said supplies used.

22. An analyzing system according to claim 1, wherein said central unit is provided with a data link to a laboratory information system LIS.

23. An analyzing system according to claim 1, wherein said central unit is provided with a data link to a hospital information system HIS.

24. An analyzing system according to claim 1, wherein said central unit is provided with a data link to further laboratory systems LS.

25. An analyzing system according to claim 1, wherein said central unit and each of said single analyzers have transmitter/receiver systems for wireless data transfer.

26. An analyzing system according to claim 25, wherein said data transfer is effected by means of wireless technology in the 2.4 GHz range, utilizing a license-free ISM band.
